(19) United States
(12) Patent Application Publication
(10) Pub. No.: US 2007/0138805 A1
(43) Pub. Date: Jun. 21, 2007

(54) Power drive

(76) Inventor: Paul Moore, Birmingham (GB)

Correspondence Address: CARLSON, GASKEY & OLDS, P.C., 400 WEST MAPLE ROAD, SUITE 350, BIRMINGHAM, MI, 48009, US

(21) Appl. No.: 11/607,128

(22) Filed: Nov. 30, 2006

(30) Foreign Application Priority Data
Dec. 6, 2005 (GB) 0524856.2

(51) Int. Cl. E05C 3/06; E05C 3/16

(52) U.S. Cl. 292/216

(57) ABSTRACT

A power drive for a vehicle latch assembly includes a drive chassis and an electric motor. The electric motor has a drive shaft on which a gear is mounted. The electric motor further includes an engagement feature for locating the electric motor on the drive chassis. The drive chassis includes a mount plate having a slot for receiving the drive shaft during assembly of the power drive. The drive shaft is permitted to slide down a first portion of the slot, thereby allowing the engagement feature to be received by a second portion of the slots to radially locate the electric motor on the mount plate.

### REFERENCE TO RELATED APPLICATION

This application claims priority to United Kingdom Patent Application GB 0524856.2 filed on Dec. 6, 2005.

### BACKGROUND OF INVENTION

This invention relates generally to power drives, and in particular, but not exclusively, to power drives for vehicle door latches.

It is common to provide vehicle door latches with power driven functions, such as power locking/unlocking, power closure, or power release. These power driven functions are of increasing importance given the reliance on electrical control in modern vehicles and the increase in door seal loads that is required to isolate a vehicle cabin from wind and tire noise.

The power driven functions are typically powered by electric motors. It is common to provide the electric motor with a preinstalled pinion gear mounted on a drive shaft. This arrangement of the electric motor and the gear will often be provided as a subassembly which is subsequently assembled into a latch mechanism. However, the space envelope available to designers of the vehicle door latch is minimal. As a result, packaging of a latch assembly presents various engineering problems.

This is particularly true in packaging of the electric motor, which tends to be one of the larger components which make up the latch assembly. Furthermore, the electric motor must be retained in position on a latch chassis to a relatively high degree of tolerance to ensure that the gears driven by the electric motor do not bind or become subject to excessive wear. A known method of mounting the electric motor is to provide a mount plate with a U-shaped channel that has the same width as a mount flange. In this method, any diameter pinion gear can be used. However, the U-shaped channel does not fully retain the mount flange in the radial direction.

A known solution to this problem is to provide the latch chassis with a mount plate having an aperture of greater diameter than a diameter of the pinion gear. It is then possible to pass the pinion gear through the aperture to mount the electric motor to the mount plate. The aperture retains the electric motor in the radial plane and must therefore be dimensioned to accommodate a mount flange which is built into a casing of the electric motor. This particular method of mounting therefore limits the diameter of the pinion gear, which in turn limits the design of the latch mechanism.

It is an object of a preferred embodiment of the present invention to overcome, or at least mitigate, some of the problems described above.

### BRIEF SUMMARY OF INVENTION

Accordingly, the present invention provides a power drive for a vehicle latch assembly including a drive chassis and an electric motor. The electric motor includes a drive shaft on which a gear is mounted. The electric motor further includes an engagement feature for locating the electric motor on the drive chassis. The drive chassis includes a mount plate having a slot for receiving the drive shaft during assembly of the power drive. The drive shaft is permitted to slide down a first portion of the slot, thereby allowing the engagement feature to be received by a second portion of the slot to radially locate the electric motor on the mount plate.

A second aspect of the present invention provides a method of assembling a power drive for a vehicle latch assembly including the steps of providing a drive chassis and an electric motor. The electric motor includes a motor body, a drive shaft on which a gear is mounted, and an engagement feature for locating the electric motor on the drive chassis. The drive chassis includes a mount plate having a slot for receiving the drive shaft. The method further includes the step of sliding the motor shaft down a first portion of the slot with the gear and the motor body in opposite sides of the mount plate until the engagement feature is aligned with a second portion of the slot. The method further includes the step of moving the electric motor towards the mount plate so the engagement feature is received by the second portion of the slot to radially locate the electric motor on the mount plate.

### DESCRIPTION OF DRAWINGS

The invention will now be described by way of example only, and with reference to the following drawings, in which:

FIG. 1 is a schematic plan view of a drive assembly of the current invention;

FIG. 2 is a schematic end view of the drive assembly of FIG. 1;

FIG. 3 is an enlarged schematic plan view of a portion of the drive assembly of FIG. 1 showing a pinion and a mount plate in further detail;

FIG. 4 is an isometric representation of the drive assembly of the current invention; and

FIG. 5 is a plan view of part of an alternative embodiment of the drive assembly according to the present invention.

### DETAILED DESCRIPTION OF INVENTION

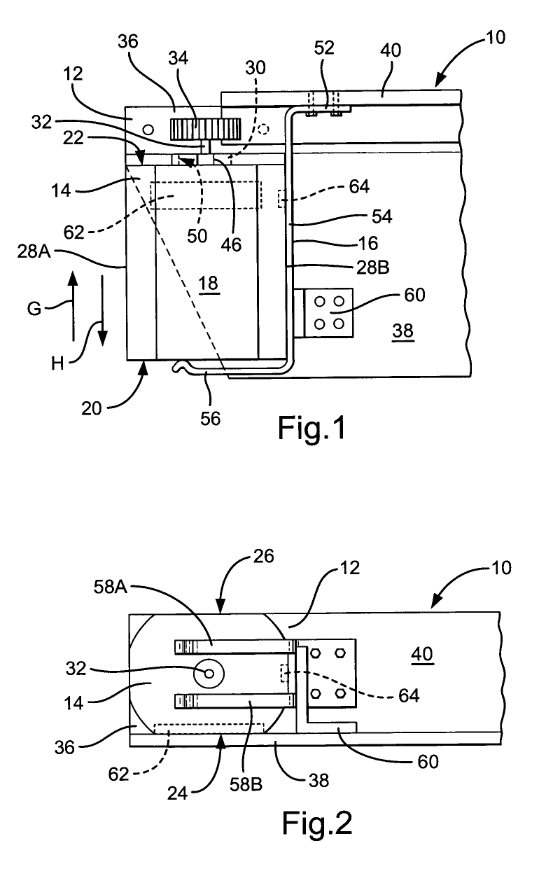

FIG. 1 illustrates a power drive assembly 10 having a drive chassis 12, an electric motor 14 and a retention arm 16. The power drive assembly 10 forms part of a latch assembly (not shown for clarity) which is mounted in a vehicle door, as will be described in further detail shortly.

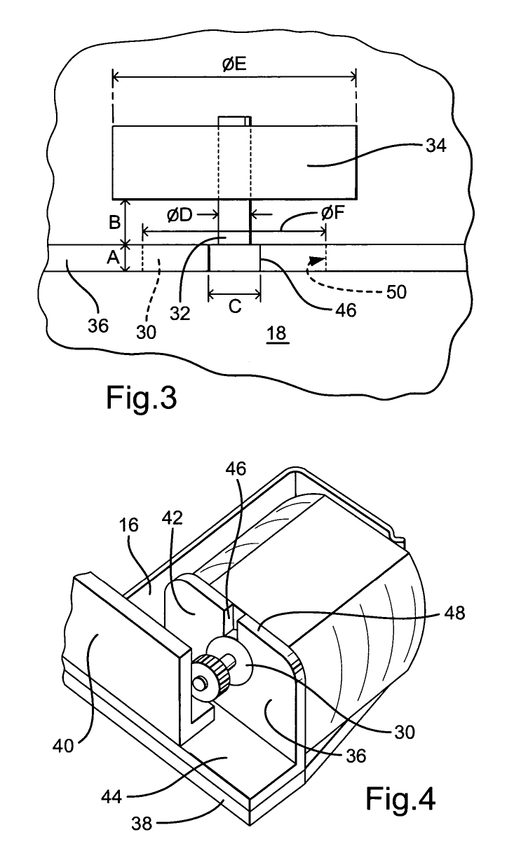

The electric motor 14 includes a motor body 18 having a rear face 20, a front face 22, a bottom face 24, a top face 26 and side faces 28A and 28B. The front face 22 defines a protruding boss in the form of a mount flange 30 (shown in dotted lines in FIG. 1 and more clearly in FIG. 3). The mount flange 30 surrounds a drive shaft 32 on which a pinion, or gear 34, is mounted for driving a latch assembly mechanism (not shown). The mount flange 30 has a circular cross-section.

The drive chassis 12 is defined by a mount plate 36, a base plate 38 and a support plate 40. In this particular embodiment, the mount plate 36, the base plate 38 and the support plate 40 are defined by separate components joined by a known method, such as bolting, riveting, welding or bonding. However, it is conceivable within the scope of the invention that these features could be provided by a single component or that the drive chassis 12 could be provided without the support plate 40.

The mount plate 36 includes an upright portion 42 and a base portion 44. The upright portion 42 defines a slot 46 which extends from a top edge 48 of the upright portion 42 to an aperture 50. The aperture 50 is generally circular and is dimensioned to achieve a push fit with the circular mount flange 30 of the electric motor 14 to prevent the electric motor 14 from moving radially (i.e., in a direction parallel to the upright portion 42 of the mount plate 36) with respect to the mount plate 36. The base portion 44 is attached to the base plate 38 by any known manner.

The retention arm 16 includes a mount portion 52, a first portion 54 and a second portion 56, and is of a resilient nature. The mount portion 52 is mounted by rivets (or other known attachment features) to the support plate 40. In other embodiments, it would be conceivable that the mount portion 52 would mount directly to the base portion 44 of the mount plate 36 or directly to the base plate 38. The first portion 54 of the retention arm 16 extends at 90 degrees to the mount portion 52 and extends along the side face 28B of the electric motor 14. The second portion 56 is arranged at 90 degrees to the first portion 54 and is defined by a first resilient arm 58A and a second resilient arm 58B. The first resilient arm 58A is arranged above the drive shaft 32 as shown in FIG. 2, and the second resilient arm 58B shown is below the drive shaft 32.

An abutment 60 is mounted to the base plate 38 to retain the first portion 54 of the retention arm 16 in position. This prevents the retention arm 16 from moving away from the side face 28B and allows the second portion 56 of the retention arm 16 to hold the electric motor 14 firmly in position.

An electrical connector 62, shown in dotted lines in FIGS. 1 and 2, is arranged between the electric motor 14 and the base plate 38. This provides an interface between a central control unit (not shown for clarity) and the electric motor 14 to control drive of the gear 34, as will be described in further detail shortly. The electric connector 62 includes a plug (not shown for clarity) arranged on the base plate 38 and a socket (not shown for clarity) arranged on the electric motor 14. It will be appreciated that within the scope of the invention, the plug could be arranged on the electric motor 14 and the socket arranged on the base plate 38. In this embodiment, the electric motor 14 is mounted onto the mount plate 36 before the base plate 38 (which carries the plug) is fixed in position.

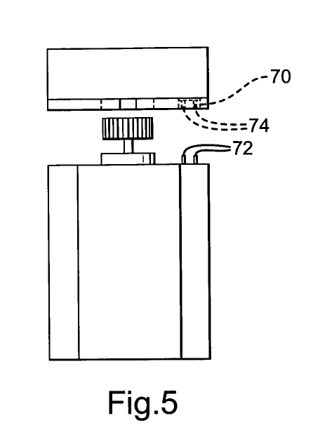

The subsequent fixing of the base plate 38 to the mount plate 36 inserts the plug into the socket to form the electrical connection. In an alternative embodiment (shown in FIG. 5), a connector 70 is shown in which a pair of plugs 72 are provided on the front face 22 of the electric motor 14 for engagement with a pair of sockets 74. In this embodiment, the plug 72 moves into the socket 74 in the same direction of movement as the electric motor 14 mounting onto the mount plate 36. While the sockets 74 are provided on the mount plate 36, and the plugs 72 engage the sockets as the electric motor 14 is being mounted on the mount plate 36, it is conceivable that the electric motor 14 could carry the socket 74 and the mount plate could carry the plug 72. This embodiment allows the base plate 38 to be fixed to the mount plate 36 before mounting the electric motor 14 into the mount plate 36. In a yet further embodiment, the socket 74 (on the electric motor 14) is elongate to allow the plug 12 (on the base plate 38) to be inserted into the socket, and the socket 74 is then moved forward about the plug 72 to allow the electric motor 14 to be mounted onto the mount plate 36 after fitting the base plate 38 in position.

The retention arm 16 additionally defines a projection 64 which prevents the electric motor 14 from rotating relative to the mount plate 36 when the gear 34 is driven by the electric motor 14.

In use, the power drive assembly 10 forms part of a vehicle latch assembly, with the gear 34 being arranged to drive one of a number of power mechanisms (for example, child safety on/off, lock/unlock of the latch, or power closure of the latch). The drive chassis 12 may therefore often form part of, or even be defined by, a vehicle latch assembly chassis.

On receipt of a signal from the central control unit (not shown) via the electrical connector 62, the electric motor 14 drives the gear 34, which in turn acts on a latch assembly gear (not shown for clarity) to achieve a change in status in the latch. The power drive assembly 10 will frequently be located in a vehicle door or a boot lid. Alternatively, it may form part of the vehicle latch assembly mounted on the vehicle body.

As mentioned above in this particular embodiment, the mount flange 30 and the corresponding aperture 50 are circular shaped. In alternative embodiments conceivable within the scope of the invention, the profile of the mount flange 30 and the aperture 50 could be other than circular, for example square, oblong or some other polygonal shape. Where this is the case, a projection 64 is not required because the engagement of, for example, a square aperture 50 by the similarly polygonal (square) motor flange 30, would prevent rotation of the electric motor 14 relative to the mount plate 36. Furthermore, it is conceivable that the aperture 50 and the mount flange 30 are of a different shape as long as there is sufficient contact between them to retain the electric motor 14 in position.

The particular configuration of features described above provides a distinct advantage in terms of assembly of the power drive assembly 10 as follows.

In conventional motor and mount plate arrangements, a mount plate does not define a slot which provides access to an aperture from a top surface of the mount plate and which radially retains the motor. As a result, the largest gear diameter which can be employed with the motor being fully radially retained by the mount plate is limited by a diameter of a motor flange. With the absence of a slot, assembly of the drive assembly is achieved by passing a gear through the aperture. Because the diameter of the aperture is dictated by the diameter of the motor flange, the construction of a power drive assembly with a gear diameter that is greater than a mount flange diameter presents additional complications.

However, the present invention overcomes this problem by removing the necessity of passing the gear 34 through the aperture 50. The slot 46 allows the exposed part of drive shaft 32, i.e., the part between the motor body 18 and the gear 34, to be passed down the slot 46 until the drive shaft 32 is arranged approximately at a center of the aperture 50. At this point, the electric motor 14 may be moved towards the mount plate 36 (a direction G in FIG. 1) to engage the mount flange 30 in the aperture 50.

Referring now to FIG. 3, a diameter of the gear 34 is shown at E, and a diameter of the aperture 50 is shown at F. It will be appreciated that the diameter E is greater than the diameter F. This is achievable in the present invention because the drive shaft 32 is able to pass down the slot 46 (a diameter D of the drive shaft 32 being less than a width C of the slot 46).

The gear 34 passes down a first side of the mount plate 36, and the mount flange 30 of the electric motor 14 passes down the other side of the mount plate 36 to allow the drive shaft 32 to pass down the slot 46. In the present embodiment, a depth of the mount flange 30 is less than or equal to a width A of the mount plate 36. It therefore follows that a distance B between the mount plate 36 and the gear 34 is greater than the width A of the mount plate 36. In an alternative embodiment, where the depth of the mount flange 30 is greater than the width A, a new distance B′ between the mount plate 36 and the gear wheel is greater than the depth of the mount flange 30.

Referring again to FIG. 1, the second portion 56 of the retention arm 16 acts on the rear face 20 of the electric motor 14 to retain the mount flange 30 within the aperture 50. As discussed above, to allow the drive shaft 32 to pass down the slot 46 during assembly of the power drive assembly 10, the mount flange 30 passes down the side of the mount plate 36 facing the front face 22 of the electric motor 14. For this to occur, the electric motor 14 must be displaced by at least the width of the mount plate 36 in the longitudinal direction H as shown in FIG. 1 to allow mounting of the electric motor 14 onto the mount plate 36.

Firstly, with the abutment 60 in position, the second portion 56 deflects at a junction of the second portion 56 and the first portion 54. Secondly, when the abutment 60 is not in position, the first portion 54 is able to deflect at the junction between the first portion 54 and the mount portion 52 in addition to the deflection of the second portion 56. It is nonetheless possible to assemble the power drive assembly 10 with the abutment 60 in place, however additional advantage is obtained by attaching the abutment 60 to the face plate 38 following the insertion of the electric motor 14 into its mounted position on the mount plate 36.

Assembly of the drive assembly is therefore achieved as follows. In a first step, the mount plate 36 and the support plate 40 are assembled by bolts, rivets, bonding or other known methods of attachment. Next, the drive shaft 32 is slid down the slot 46 until the drive shaft 32 is located at approximately a center of the aperture 50. The electric motor 14 is then moved forward in the longitudinal direction G (FIG. 1) to engage the mount flange 30 in the aperture 50. The base plate 38 is then fixed to the mount plate 36 by a known manner at the same time as engaging the electrical connector 62. Next, the retention arm 16 is attached to the support plate 40 or other mounting portion on the drive chassis 12. The abutment 60 is then attached to the base plate 38 to retain the first portion 54 of the retention arm 16 in position. Finally, the projection 64 is crimped or otherwise bent over to prevent rotation of the electric motor 14 with respect to the mount plate 36.

It will be appreciated that where the electrical connector of FIG. 5 is used, the base plate 38 can be fixed to the mount plate 36 before the electric motor 14 is mounted onto the mount plate 36.

It will also be appreciated that certain features of the mount plate 36, the base plate 38 and the support plate 40 may be changed within the scope of the invention.

Similarly, the particular dimensions of the retention arm 16 may be changed within the scope of the invention.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A power drive for a vehicle latch assembly, the power drive comprising:
a drive chassis including a mount plate having a slot, wherein the slot includes a first portion and a second portion, and
an electric motor including a drive shaft on which a gear is mounted, the electric motor further including an engagement feature for locating the electric motor on the drive chassis,
wherein the slot receives the drive shaft during assembly of the power drive, and
wherein the drive shaft is permitted to slide down the first portion of the slot, thereby allowing the engagement feature to be received by the second portion of the slots to radially locate the electric motor on the mount plate.

2. The power drive of claim 1 including a retention arm mounted on the drive chassis as to bias the electric motor, in use, towards the mount plate.

3. The power drive of claim 2 wherein the retention arm includes a mount section, a first section and a second section, the first section extending between the mount section and the second section along a side of the electric motor, and the second section applying a retaining load to the electric motor.

4. The power drive of claim 3 wherein an abutment is mounted on the drive chassis, and in use the first section is prevented from deflecting away from the electric motor by the abutment.

5. The power drive of claim 3 wherein the second section is defined by two resilient arms, and one of the two resilient arms is arranged above the drive shaft and the other of the two resilient arms is arranged below the drive shaft.

6. The power drive of claim 1 wherein the electric motor has a front face, and the engagement feature is longitudinally displaced from the front face the motor.

7. The power drive of claim 1 wherein the engagement feature is a flange arranged about the drive shaft.

8. The power drive of claim 6 wherein the first portion of the slot is elongate, the second portion the slot defines an aperture in communication with the first portion, and the engagement feature and the aperture are in contacts to securely locate the electric motor radially with respect to the mount plate.

9. The power drive of claim 8 wherein the aperture and the engagement feature are substantially circular in cross-section.

10. The power drive of claim 2 wherein the electric motor includes a side face and the retention arm includes a projection which engages the side face of the electric motor to hold the electric motor rotationally secure with respect to the drive chassis.

11. The power drive of claim 1 including an electrical connection arranged between the drive chassis and the electric motor to assist rotational securing of the electric motor relative to the drive chassis.

12. The power drive of claim 2 wherein the electric motor includes a front face and the retention arm is sufficiently resilient to permit movement of the electric motor away from the mount plate during assembly of the power drive by a distance, and the distance is greater than a longitudinal displacement of the engagement feature from the front face of the electric motor.

13. The power drive of claim 1 wherein the drive chassis is a vehicle latch assembly chassis.

14. A vehicle latch assembly comprising:
a power drive of a drive chassis, the drive chassis including a mount plate having a slot, wherein the slot includes a first portion and a second portion;
an electric motor,including a drive shaft on which a gear is mounted, the electric motor further including an engagement feature for locating the electric motor on the drive chassis, wherein the slot receives the drive shaft during assembly of the power drive, and the drive shaft is permitted to slide down the first portion of the slot, thereby allowing the engagement feature to be received by the second portion of the slot to radially locate the electric motor on the mount plate; and
a mechanism comprising one of a power closure mechanism a power lock/unlock mechanism, and a power opening mechanism of a power child safety on/off mechanism, wherein the gear drives the mechanism to change a status of the vehicle latch assembly.

15. A method of assembling a power drive for a vehicle latch assembly, the method comprising the steps of:
providing a drive chassis and an electric motor, wherein the drive chassis includes a mount plate having a slot, the slot having a first portion and a second portion, and the electric motor includes a motor body, a drive shaft on which a gear is mounted and an engagement feature for locating the electric motor on the drive chassis, and where the slot receives the drive shafts;
sliding the drive shaft down the first portion of the slot with the gear and the motor body on opposite sides of the mount plate until the engagement feature is aligned with the second portion of the slot; and
moving the electric motor towards the mount plate so the engagement feature is received by the second portion of the slot to radially locate the electric motor on the mount plate.

16. The method of claim 15 wherein the drive chassis includes a base plate, the method including the step of fixing the base plate to the mount plate after mounting the electric motor onto the mount plate to further support the electric motor.

17. The method of claim 15 including the steps of providing a retention arm for, in use, biasing the electric motor towards the mount plate, and mounting the retention arm on the mount plate after mounting the electric motor on the mount plate.

18. The method of claim 17 wherein the retention arm has a mount section, a first section and a second section, the first section extending between the mount section and the second section along a side of the electric motor, the second section applying a retaining load to the electric motor, the method including the step of preventing deflection of the first section away from the side of the electric motor by fixing an abutment to the drive chassis to retain the first section in place.
